(19) United States
(12) Patent Application Publication
(10) Pub. No.: US 2011/0193333 A1
(43) Pub. Date: Aug. 11, 2011

(54) MEDICINE ADMINISTRATION CARD AND RELATED METHOD OF USE

(76) Inventor: Delmer H. Parrish, Naples, FL (US)

(21) Appl. No.: 12/703,929

(22) Filed: Feb. 11, 2010

(51) Int. Cl. B42D 15/00

(52) U.S. Cl. 283/70; 283/81

(57) ABSTRACT

The invention is directed to a medication administration card that includes a sheet of rigid material having a first and second side, the sheet also having a first portion, a second portion and a folded edge located between both portions. The sheet includes at least one row of spaced cavities having at least five spaced cavities which correspond to the days of the week located on the second portion of the sheet each spaced cavity of sufficient size and dimension to maintain one or more pills having a surface area, at least one row the sheet includes an additional spaced cavity for a spare pill or pills. Spanning across these spaced cavities is a metallic foil layer. A label on the second portion of the sheet includes an identifier proximate to each spaced cavity to identify each weekday and a separate identifier to denote a spare set of pills.

### FIELD OF THE INVENTION

This invention is directed to a medicine administration card and related method of use. More specifically, the invention relates to a punch card that allows customized placement of a patient's weekly or monthly drug regiment, as well as spare medication in the event a dose is compromised.

### BACKGROUND OF THE INVENTION

Skilled nursing facilities, also commonly referred to as nursing homes, provide a variety of medical services for those in need of twenty-four hour medical and convalescent care. There are over 16,000 nursing homes within the United States alone and countless other facilities that provide long term care for those who cannot live alone.

One issue in long term health care, including nursing home care, is the proper and efficient administration of each patient's prescribed medication. Each patient invariably has a unique set of medication to be administered throughout the week. This regiment can change monthly depending upon the nature of the patient's medical conditions and treatment program. Because of this, medical professionals spend a large amount of time each day administering each patient's medication.

Several rudimentary devices have been developed which help assist medical providers to administer medication in long term care institutions like nursing homes. One popular method is commonly referred to as a “punch card.” In current punch cards, there is a simple two-sided folded cardboard ply sheet having a first portion and a corresponding opposing second portion which creates a cavity to hold pills. On the second portion, there are thirty to thirty-one equally spaced openings having a sufficient size and dimension to maintain these pills. Covering each of these holes is a portion of metallic foil.

A pharmacist or other similar medical professional can arrange a patient's prescribed medication on the various metallic foil portions covering each opening in the second portion of the sheet. Next, the first portion can be folded over the arranged pills and affixed to the second portion to create a cavity. The sheet can then be heated to mold to the dimensions of the various pills.

With traditional punch cards, there is a rudimentary numbering system of simply one through thirty (or alternatively thirty one). This numbering system has multiple drawbacks and limitations. First, in scenarios where a patient is only taking a medication on certain days (i.e., Monday, Wednesday, and Friday), this rudimentary numbering system fails to record and denote when the last time the patient was administered the medication. Second, if a pill is compromised (i.e., it breaks within the punch card or falls on the floor upon release) there is no way to denote this or to account for the accident. Rather, the only choice is to withdraw the next available pill from the punch card.

Lastly, current punch cards fail to provide any basis for pharmacists (or related medical professionals) to denote potential side effects of the drug regiment or improper drug combinations. This all leads to inefficiency and the need for over ordering of prescription drugs—all of which represents added costs for the patent and medical provider. For example, a compromise in a daily dose of medications may require a secondary punch card to be ordered which will require another thirty pills to be assembled and provided for patient use. This all results in wasted medication and the higher cost of medical care.

Accordingly, there is a need in the art of administering drug regiments in a more efficient manner. Moreover, there is a need to more carefully denote when a drug is administered in a non-daily regiment. Finally, there is a need for a more advanced punch card that provides more accurate and detailed information.

### SUMMARY OF THE INVENTION

This invention solves many of the current limitations presently found punch card systems. One embodiment of the medical administration card includes a sheet of rigid material having a first side and a corresponding second side, the sheet also having a first portion, a corresponding opposing second portion and a folded edge located between the first portion and second portion wherein both portions (when folded) form a cavity of sufficient size and dimension to hold and maintain one or more pills. The second portion of the sheet includes at least one row of spaced openings having at least five spaced openings that correspond to the workweek located on the second portion of the sheet. Each spaced cavity is of sufficient size and dimension to maintain one or more pills having a defined surface area. At least one row that includes an additional spaced cavity for a spare set of pills.

Placed on the second portion of the sheet is a metallic foil layer that spans at least one spaced cavity. A label also located on the second portion includes an identifier proximate to each spaced opening to identify each weekday as well as a separate identifier to denote a spare set of pills. The label can further include a portion that allows a medical professional to record the patient's medical history and place notes regarding administration of medication to the patient. An adhesive member—which can be glue or staples—attaches the first portion of the sheet to the second portion to maintain the set of pills. Again, this forms a cavity between both sheets to maintain and store the arranged pills.

In another embodiment, the sheet can have four rows of spaced cavities, each row having at least seven spaced openings (and accordingly at least seven cavities) to correspond to the seven days of the week. According the label has four rows of identifiers, each row identifying the seven days of the week proximate to each of the spaced cavities on the second side of the sheet. Optionally, a coating can be placed on the sheet that includes an antibacterial composition.

In addition the invention is directed to a preferred method of administering a drug regiment. The method includes the steps of (a) positioning a sheet sufficient to review the sheet's contents, the sheet being of rigid material having a first side and corresponding second side, the sheet including a first portion, a corresponding opposing second portion and a folded edge located between the first portion and second portion wherein both portions form a cavity to hold and maintain one or more pills; (b) viewing a label contained on the second portion of the sheet, the label including identifiers proximate to a plurality of spaced openings which denote each date of the week as well as a separate identifier which identifies a spare quantity of one or more pills, the spaced openings (which form corresponding cavities) being of sufficient size and dimension to maintain one or more pills and having a defined surface area; (c) releasing a set of one or more pills based upon the particular day of the week from the sheet through breaking a metallic foil layer attached to the second portion of the sheet which spans at least one of the spaced cavities, the release being based upon an identifier of that particular day located proximate to the to-be-breached metallic foil layer; and (d) repeating steps (a) through (c) until a pre-determined number of pills have been removed.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 provides a front view of a prior art punch card for administration of a monthly regiment of drug therapy;

FIG. 2 is a front view of one embodiment of the improved punch cart that allows for a five-day four week regiment of drug therapy; and

FIG. 3 is a front view of a second embodiment of the improved punch card that allows for a seven-day four week regiment of drug therapy.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

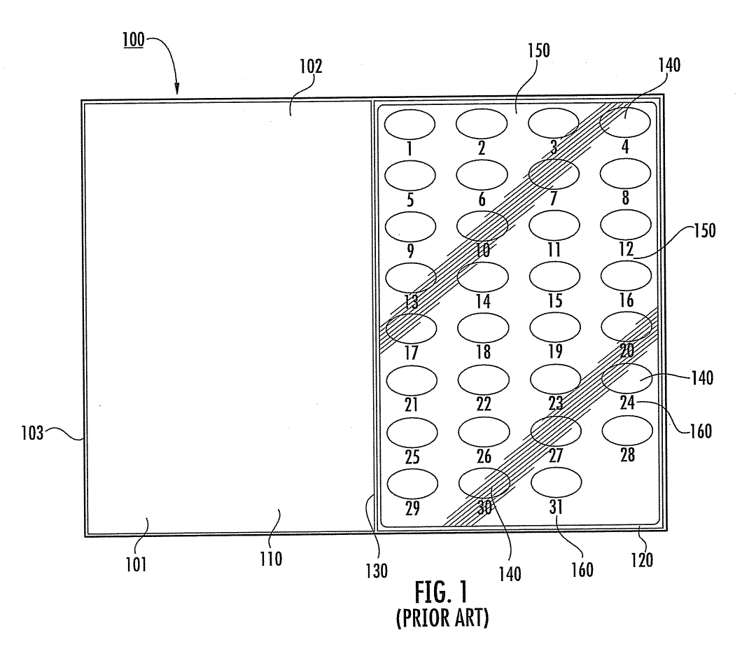

FIG. 1, a direct view of a well-known punch card 100, is herein presented by way of example. As illustrated, a currently available punch card 100 is typically a sheet 101 that includes a first side 102 and a corresponding second side 103. In addition, the sheet 101 typically includes a first portion 110 and a corresponding opposing second portion 120, defined on at least one of the first 102 and second sides 103. Located between the first portion 110 and second portion 120 is a folded edge 130. Folding both the first portion 110 onto the second portion 120 creates a cavity of sufficient size and dimension to arrange, maintain and house one or more pills. The sheet 101 is rigid in construction and made of cardboard.

Positioned on the second 120 portion of the sheet 101 is a plurality of spaced openings 140. Essentially, each spaced opening 140 is a circular or oval shaped hole punched or placed within the sheet 101. Such opening 140 can be punched through the sheet 101 during manufacture. Each spaced opening 140 is of sufficient size and dimension to allow penetration by a plurality of pills.

Placed over the sheet 101 is a metal foil layer 150. The metal foil layer 150 spans across all of the various spaced openings 140. This metal foil layer 150 is preferably aluminum. As further shown in FIG. 1, there are thirty-one spaced cavities 140—each covered by the metal foil layer 150. The second portion 120 also includes a rudimentary label 160 that includes the numbers one through thirty (which correspond to the number of days in the calendar month). A cavity of sufficient dimension to arrange and maintain one or more pills is created through the metallic foil layer 150 spanning across an opening 140 on the second portion 120 as well as the surface of the first portion 110.

### The Workweek, Five Day Punch Card

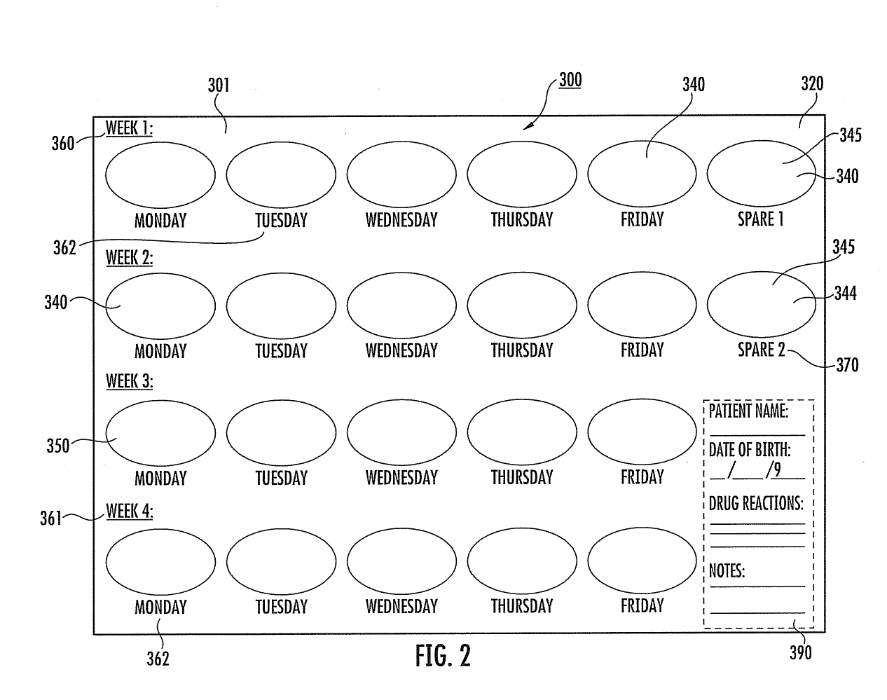

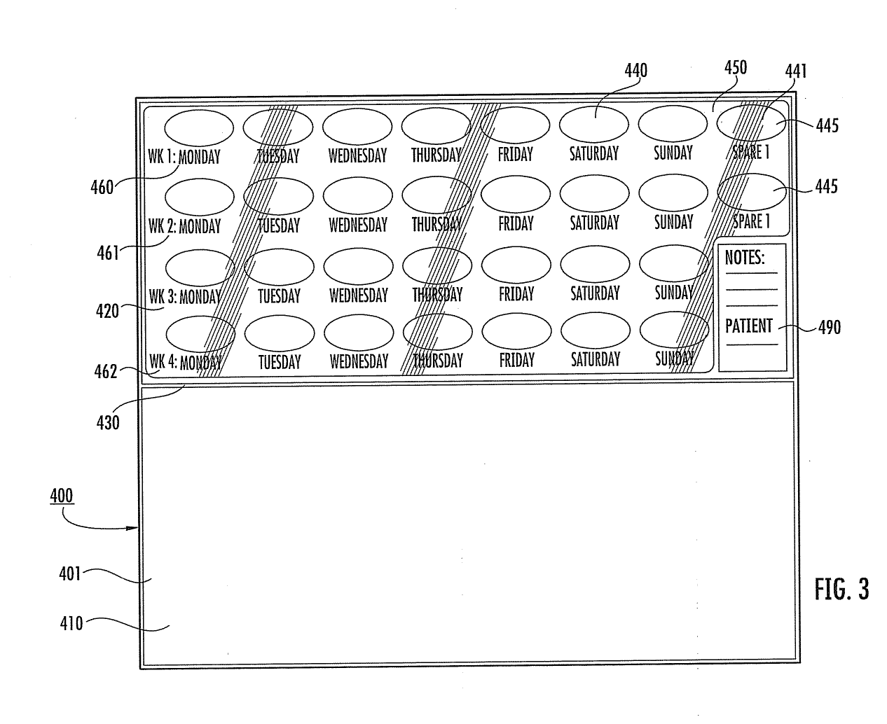

FIG. 2 illustrates one embodiment of an improved punch card 300, by way of example in keeping with the teachings of the present invention. There exist multiple variations and arrangements for the improved punch card 300. Illustrated in FIG. 2 is one embodiment of the punch card 300 for administration of medicine just during the workweek (Monday through Friday). However, as illustrated in greater detail below and in FIG. 3, the invention also contemplates a punch card 400 for administering drugs throughout the entire week (Monday through Sunday). Other arrangements will be known and understood by those of ordinary skill in the art through review of FIGS. 2 and 3. For example, a punch card 300 could be arranged to begin on a Friday (when the cards are to be delivered to the nursing facility) to end on the following Thursday.

Now turning to FIG. 2, the embodiment shows an improved punch card 300. The improved punch card 300 includes a sheet 301 which can be manufactured from various improved materials including cardstock, polymers, composites and other rigid yet light weight material known to those of ordinary skill in the art. The improved punch card 300 includes a first portion 310 (not shown), a corresponding opposing second portion 320, and a folded edge 330 (not shown) positioned between the first and second portions (310 and 320).

Located on the second portion 320 is a plurality of spaced openings 340. The spaced cavities 340 are of sufficient size and dimension to withdraw a set of one or more pills. Each spaced opening 340 is a circular or oval shaped hole punched or placed within the sheet 301. Positioned over one or more of the spaced openings 340 is a metallic foil layer 350. The metallic foil 350 can be made of aluminum, a weak breakable polymer, composite or other similar material known to those of ordinary skill in the art. The purpose of the metallic foil layer 350 is to create a material sufficient to break and remove the stored pills through application of pressure placed onto the punch card 300 by the administering medical professional. A cavity of sufficient dimension to arrange and maintain one or more pills is created through the metallic foil layer 350 spanning across an opening 340 on the second portion 320 as well as surface of the first portion 310.

As further shown in FIG. 2, the improved punch card 300 includes several rows of spaced openings 340 (which correspondingly form several rows of cavities), each row having at least five spaced openings 340—which correspond to the number of days in the workweek. In addition, at least one of the rows of spaced openings 340 (and likewise cavities) contains an area for an additional spaced opening 341 to house and maintain a spare 345 set of pills. The pills are secured and housed within the cavity by affixing the first portion 310 (not shown) onto the second portion 320 through some adhesive that can be staples, glue or other affixing means.

This spare 345 is provided in the event that a pill is compromised (i.e., breaks or is dropped and lands on the floor). In the prior art system illustrated in FIG. 1, if a pill is compromised—the medical professional's only option is to break the metallic foil 150 of the next available cavity—without any ability to denote the compromised pill. Moreover, the medical professional will then be required to order a substitute punch card 100 all resulting in waste of the underlying medication and increased cost to the patient. Under the improved punch card 300 shown in FIG. 2, the answer to a compromised set of pills is to simply open and remove a spare 345.

FIG. 2 also illustrates how the improved punch card 300 includes a detailed label 360. The detail label 360 includes each particular week 361 for administration (i.e., Week 1, Week 2, Week 3, etc.), as well as the particular days 362 (here, Monday through Friday). In addition, the label includes a notes section 370. The notes section 390 allows a medical professional to record the patient's name, medical history as well as any risk as to mixing with other medications.

The advantage of the improved punch card 300 detailed label 360 are numerous. For example, if a patient needs only to take medicine on Mondays, Wednesdays and Fridays, the improved punch card 300 can be prepared such that pills are only placed on the spaced cavities which correspond to the labels 360 for Monday, Wednesday and Friday. A separate label 370 also denotes the spare or spares available. Accordingly, after a medical professional removes the pills through breaking the metal foil layer 350, there is a clear record that the patient has taken the medication on that day. As a second related benefit, this allows use of less medication thus lending to a greater savings for the patient.

In comparison, the prior art punch card 100 shown in FIG. 1 fails to denote when medication was actually taken. Rather, there is only a notation as to how many pills were taken.

### Seven-Day Punch Card

FIG. 3 offers a direct view of second embodiment of an improved punch card 400, by way of example in keeping with the teachings of the present invention. In this embodiment, the improved punch card 400 allows for administration of medication on each day of the week (Monday through Sunday). This improved punch card 400 includes a sheet 401 having a first portion 410, a corresponding opposing second portion 420, and a folded edge 440 located between both portions (410 and 420). The sheet 401 can be made of any rigid and light weight material known to those of ordinary skill in the art—but is preferably made of cardstock or cardboard.

Located on the second portion 420 is a plurality of spaced openings 440. The spaced openings 440 are of sufficient size and dimension to withdraw a set of one or more pills (from the cavities formed between the spaced openings of the second portion 420 and a side of the first portion 410). Each spaced opening 440 is a circular or oval shaped hole punched or placed within the sheet 401. Positioned over one or more of the spaced openings 440 is a metallic foil layer 450. The metallic foil 450 can be made of aluminum, a weak breakable polymer, composite or other similar material known to those of ordinary skill in the art. The purpose of the metallic foil layer 450 is to create a material sufficient to break and remove the stored pills through application of pressure by the administering medical professional. A cavity is formed through combination of the metallic foil 450 and a side of the first portion 410 of the sheet 400.

As further shown in FIG. 3, the improved punch card 400 includes four rows of spaced cavities, each row having at least seven spaced openings 340—which correspond to the number of days in the entire week. In addition, at least one of the rows of spaced openings 440 contains an area for an additional spaced opening 441 to maintain a spare 445 set of pills. The pills are maintained and housed through the cavity formed by affixing the first portion 410 onto the second portion 420 through some adhesive, which can be staples, glue or other affixing means.

FIG. 3 further illustrates how the improved punch card 400 includes a detailed label 460. This detailed label includes each particular week 461 for administration (i.e., Week 1, Week 2, Week 3, etc), as well as the particular days 462 (here, Monday through Sunday). In addition, the label includes a notes section 490. The notes section 490 allows a medical professional to record the patient's name, medical history as well as any risk as to mixing with other medications.

The sheet 401 can be coated with an antibacterial, anti-microbial or similar agent.

### Method of Using the Improved Punch Card

The invention is further directed to a method of using the improved punch card 400 when administering medication. The method first includes positioning a sheet 401 sufficient to review the sheet's 401 contents, the sheet being manufactured of a rigid material such as cardboard or card stock. The sheet 401 is preferably rectangular in shape but can be of any suitable shape and size. The sheet 401 including a first side 402, a corresponding second side 403, a first portion 410 and a corresponding opposing second portion 420. In addition, the sheet 401 includes a folded edge 430 located between the first portion 410 and the second portion 420 that form a cavity.

The second step of the method is viewing a label 460 contained on the second portion 420 on the sheet. The label 460 includes identifiers proximate to a plurality of spaced openings 440, which denote each date of the week as well as a separate identifier, which identifies a spare 445 quantity of one or more pills. The spaced opening 440 (which correspondingly form a cavity through a side of the first portion 410) is of sufficient size and dimension to maintain a set of one or more pills having a defined surface area.

The third step of the method is releasing a set of one or more pills based upon the particular day of the week from the sheet 401 through breaking a metallic foil layer 450 attached to the second portion 420 of the sheet 410 which spans at least one of the spaced cavities, the release being based upon an identifier of that particular day located proximate to the to-be-breached metallic foil layer 450. Other identifiers can be included on the label 460, such as a particular week, the days of administration, preferred times for administration of medication, and suggestions as how to administer (i.e., how medicine should be taken with water, food, etc.).

Each of the three aforementioned steps are repeated each day until a pre-determined number of pills have been removed—or the improved punch card 400 is empty. For example, when a four-week (Monday through Sunday) supply of pills have been consumed, the method necessarily stops and a new sheet 401 is ordered. In addition to the above, the method can further include the step of recording medical information on a notes section 490 of the label 460.

I claim:

1. A medication administration card comprising:
a sheet of rigid material having a first side and a corresponding opposing second side, the sheet also having a first portion, a corresponding second portion and a folded edge located between the first portion and second portion wherein both portions form a cavity sufficient to maintain one or more pills;
at least one row of spaced openings, each row having at least five spaced cavities to correspond to the days of the work week located on the second portion of the sheet; each cavity of sufficient size and dimension to maintain one or more pills having a surface area, at least one row of the sheet including an additional cavity for a spare pill or pills;
at least one metallic foil layer, the metallic foil layer attached to the second portion of the sheet and capable of spanning at least one spaced opening;
a label located on the second portion of the sheet, the label including an identifier proximate to each spaced cavity to identify each day of the week as well as a separate identifier to denote a spare set of one or more pills; and
an adhesive member sufficient to attach the first portion of the sheet to the second portion in order to maintain one or more sets of pills.

2. The administration card of claim 1, wherein:
the label can further include a portion that allows a medical professional to record a patient's name and medical history.

3. The administration card of claim 2, wherein:
the label can further allow a medical professional to place notes regarding administration of medication to a patient.

4. The administration card of claim 1, wherein:
the sheet has four rows of spaced cavities, each row having at least seven spaced cavities to correspond to the seven days of the week.

5. The administration card of claim 4, wherein:
the label having four rows of identifiers, each row identifying the seven days of the week proximate to each of the spaced cavities on the second side of the sheet.

6. The administration card of claim 1, further comprising:
a coating placed upon the sheet, the coating including an antibacterial composition.

7. A medication administration card comprising:
a sheet of rigid material;
at least one row of spaced cavities, each row having at least seven spaced openings to correspond to the days of the week located on the second portion of the sheet each spaced cavity of sufficient size and dimension to maintain one or more pills having a surface area, at least one row of the sheet including an additional spaced cavity for a spare pill or pills;
at least one metallic foil layer, the metallic foil layer attached to the sheet and capable of spanning at least one spaced opening; and
a label located on the sheet, the label including an identifier proximate to each spaced cavity to identify each day of the week as well as a separate identifier to denote a spare set of one or more pills.

8. The administration card of claim 7, wherein:
the label can further include a portion that allows a medical professional to record a patient's name and medical history.

9. The administration card of claim 7, wherein:
the label can further allow a medical professional to place notes regarding administration of medication to a patient.

10. The administration card of claim 7, wherein:
the sheet having four rows of spaced cavities, each row having at least seven spaced cavities to correspond to the seven days of the week.

11. The administration card of claim 7, wherein:
the label having four rows of identifiers, each row identifying the seven days of the week proximate to each of the spaced cavities on the second side of the sheet.

12. The administration card of claim 7, further comprising:
a coating placed upon the sheet, the coating including an antibacterial composition.

13. A method of administering medication, comprising the steps of:
(a) positioning a sheet sufficient to review the sheet's contents, the sheet being of rigid material having a first side and corresponding second side, the sheet including a first portion, a corresponding opposing second portion and a folded edge located between the first portion and second portion wherein both portions form a cavity sufficient to maintain one or more pills;
(b) viewing a label contained on the second portion of the sheet, the label including identifiers proximate to a plurality of spaced cavities which denote each date of the week as well as a separate identifier which identifies a spare quantity of one or more pills, the spaced cavity being of sufficient size and dimension to maintain one or more pills and having a defined surface area;
(c) releasing a set of one or more pills based upon the particular day of the week from the sheet through breaking a metallic foil layer attached to the second portion of the sheet which spans at least one of the spaced cavities, the release being based upon an identifier of that particular day located proximate to the to-be-breached metallic foil layer;
(d) repeating steps (a) through (c) until a pre-determined number of pills have been removed.

14. The method of claim 13, further comprising the step of:
recording patient medical information on a portion of the label.

15. The method of claim 13, wherein:
the label can further allow a medical professional to place notes regarding administration of medication to a patient.

16. The method of claim 13, wherein:
the sheet having four rows of spaced cavities, each row having at least seven spaced cavities to correspond to the seven days of the week.

17. The method of claim 16, wherein:
the label having four rows of identifiers, each row identifying the seven days of the week proximate to each of the spaced cavities on the second side of the sheet.

18. The method of claim 13, wherein:
the sheet includes a coating that includes an anti-bacterial agent.
